(19) United States
(12) Patent Application Publication
(10) Pub. No.: US 2013/0097139 A1
(43) Pub. Date: Apr. 18, 2013

(54) PROGRAMMABLE MULTI-FILTERING

(71) Applicants: Simon Thoresen, Trondheim (NO); Henning Baldersheim, Trondheim (NO); Haavard Pettersen, Trondheim (NO); Jon S. Bratseth, Trondheim (NO)

(72) Inventors: Simon Thoresen, Trondheim (NO); Henning Baldersheim, Trondheim (NO); Haavard Pettersen, Trondheim (NO); Jon S. Bratseth, Trondheim (NO)

(21) Appl. No.: 13/275,111

(22) Filed: Oct. 17, 2011

(51) Int. Cl. G06F 17/30

(52) U.S. Cl. 707/706; 707/776; 707/E17.032; 707/E17.108

(57) ABSTRACT

A method and apparatus are presented for: receiving a search query, comprising a query select statement and a plurality of search terms; generating a plurality of selection models based on the query select statement and the plurality of search terms, wherein each selection model, from the plurality of selection models, comprises a unique combination of one or more terms, from the plurality of search terms, that is not present in other selection models, from the plurality of selection models. A plurality of particular selection results is obtained for a particular selection model for each particular selection model, from the plurality of models. The plurality of particular selection results are grouped to a final result and aggregated according to the selection models, and the aggregated final result is presented to a user.

### FIELD OF THE INVENTION

Techniques of the present disclosure relate to generating search results for a search query, and more specifically to grouping and aggregating search results according to selection models.

### BACKGROUND

Search engines are designed to provide data mining services. The approaches for developing data mining search engines may vary and may depend on the criteria that the search engine should meet. For example, some data mining applications can be optimized to return a significant quantity of relevant documents (hits, matches) in response to a search query submitted to the search engine. That may require developing algorithms for determining a relevancy of the documents returned in response to a search query. Also, that may require developing algorithms for determining measures of a document relevancy and for determining content of the returned documents.

Other data mining application can be optimized to generate various views of the returned documents. For example, the application can be configured to organize a list of returned documents not only by the scores associated with the documents, but also to organize the list of the returned documents by some additional criteria.

However, both groups of the applications may be unable to supplement the list of returned documents with aggregated information generated for the returned documents. For example, if a user submitted a search query seeking the titles of music albums recorded by a well known artist—Michael Jackson, then it may be desirable to provide not only the list of the albums, but also to provide some information indicating aggregated details about each album. Such information may help the user to determine the album that can be the most relevant to the user's search. Furthermore, such information may help the user to refine his generic search query and formulate a more specific query.

Hence, providing aggregated information for groups of the search results in addition to an organized list of the search results enhances the user's experience from initiating a search session and finding the desired result. It also makes the process efficient by optimizing the number of transactions required to build final aggregated results.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an embodiment of a search engine environment;

FIG. 2 illustrates a data flow associated with processing grouping requests;

FIG. 3 illustrates an embodiment of generating of selection models and execution models;

FIG. 4 illustrates an embodiment of relationship between an execution model and execution result;

FIG. 5 illustrates an embodiment of an example of a display generated for grouped search results;

FIG. 6 illustrates an embodiment of an approach for programmable multi-filtering;

FIG. 7 illustrates a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Programmable Multi-filtering of Search Results
4.0 Example of an Embodiment of Programmable Multi-filtering
5.0 Implementation Mechanisms—Hardware Overview
6.0 Extensions and Alternatives

1.0 General Overview

Techniques disclosed herein include approaches for programmable multi-filtering of search results. Programmable multi-filtering can be applied to a variety of data mining applications, and in particular to data mining applications implemented in search engines.

In an embodiment, programmable multi-filtering of search results is performed in two phases. One phase can be referred to as a back-end phase, and pertains to an initial processing of a search query. It can involve transforming a search query into a multiple back-end requests which, once executed, provide one or more sets of search results. Another phase can be referred to as a front-end phase, and pertains to processing of the obtained search results.

In particular, in an embodiment, a back-end phase involves receiving a search query, parsing the search query, generating a plurality of selection models, generating a plurality of back-end requests, and executing the back-end requests to generate a set of search results. The search query can comprise a query select statement and a plurality of search terms. The plurality of selection models can be generated based on the query select statement and the plurality of search terms. Each selection model, from the plurality of selection models, can comprise a unique combination of one or more terms, from the plurality of search terms, that is not present in other selection models, from the plurality of selection models.

In an embodiment, the back-end phase processing further comprises obtaining a plurality of particular selection results for a particular selection model for each particular selection model, from the plurality of models.

In an embodiment, one or more search cores execute a plurality of execution models by mining multi-dimensional information extracted from distributed search engine results.

In an embodiment, a plurality of particular selection results is grouped to a set of search results.

In an embodiment, a front-end phase involves analyzing and aggregating a set of search results. The grouping and aggregating of the search results can be executed in parallel.

In an embodiment, grouping of the search results is performed based on one or more selection models identified in a back-end phase of the processing, which used one or more attributes associated with the models. For example, using a particular attribute of the search results, the search results that are associated with the same value of the particular attribute can be grouped to one group. Other search results that are associated with another value of the particular attribute can be grouped to another group. For instance, if a search query was issued to return the names of music albums recorded after year 2005, then all returned names of the albums can be grouped based on the names of the artist. If the returned search results indicate one hundred (100) different names of the artists, then the returned search results can be potentially divided into one hundred different groups.

In an embodiment, groups identified from the search results can be graphically represented in a tree-structure. For example, if ten groups were identified from the search results, then a corresponding tree-structure can be represented as a tree having a root and ten branches originated from the root. According to another example, the tree-structure can have nested brunches, which represent groups and subgroups of the search results.

In an embodiment, a grouping level (level) is identified for each group identified for search results. A level associated with a particular group can represent the level in a hierarchical tree-structure. For example, if a search query was issued to return the names of music albums recorded after year 2005, then the returned search results can be grouped based on the name of the artist, and within each group associated with a particular artist, one or more subgroups representing a particular type of music in a recorded album can be also identified.

In one scenario, a grouping based on the name of the artist can be associated with a first level of grouping, while a grouping based on the type of music in the album can be associated with a second level. In this scenario, the search results are first grouped based on the name of the artist, and then, for each artist, the results in a group can be grouped based on the type of the recorded music albums. The two levels can be represented in a hierarchical tree-structure by two levels originated at a root. A first group level can comprise different names of the artists, while a second group level can comprise different types of music albums for each artist.

In another scenario, a grouping based on the type of music in the album can be associated with a first level, while a grouping based on the name of the artist can be associated with a second level. In this scenario, the search results are first grouped based on the type of the recorded music albums, and then, for each type of music, the search results are grouped based on the name of the artist. The two levels can be represented in a corresponding hierarchical tree-structure by two levels originated at a root. A first group level can comprise different types of music albums, while a second group level can comprise different names of the artists for each type of music albums.

In an embodiment, information about each group of search results can be aggregated. For example, if search results providing the names of music albums recorded after 2005 were divided into groups based on the name of the artist, then aggregated information associated with the group can comprise information about the quantity of music tracks recorded by the particular artist, the quantity of hits recorded by the particular artist, the quantity of search-hits that were issued for the particular recording, the average price of the recording/albums recorded by the particular artist, the minimum and the maximum prices of the recordings/albums recorded by the particular artist, and other information that can be derived from the search results. Furthermore, the aggregated information can provide information summarizing a musical career of the particular artist, the artist' accomplishments, awards, recorded albums and other information about the artist.

In an embodiment, groups of search results and aggregated information associated with the groups are presented to a user. For example, the groups and aggregated information can be displayed in a graphical user interface displayed for the user.

In an embodiment, a graphical user interface comprises a panel for a result display, a panel for any of a timeline data display, a panel for a hit-map display, a panel for a demographic information display, a panel for a price range display, and any other panel that can be used to display data.

2.0 Structural and Functional Overview

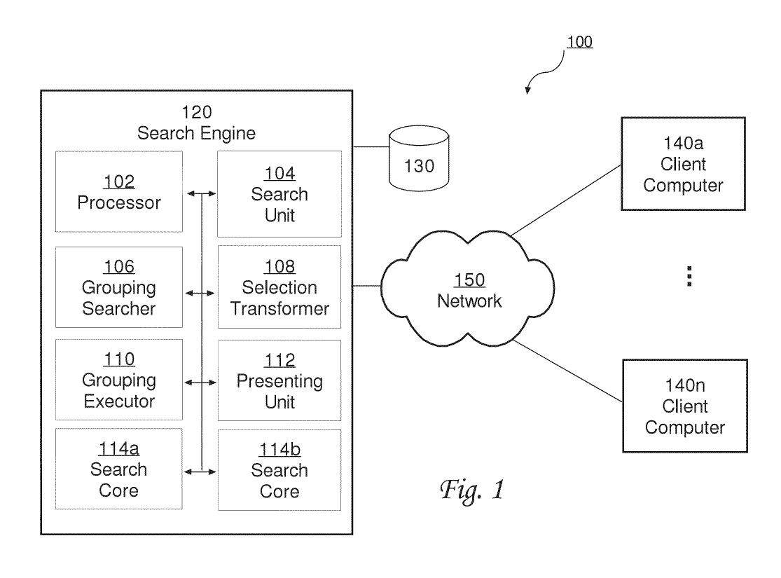

FIG. 1 illustrates an embodiment of a search engine environment 100. The search engine environment 100 comprises one or more search engines 120, one or more databases 130, one or more client computers 140a . . . 140n, and one or more computer networks 150. Other components, such as servers, routers, data repositories, data clouds, can be included in the search engine environment 100.

In an embodiment, a search engine 120 is configured to collect information available on the Internet or dedicated data repositories, process the collected information and store the processed information in storage, such as a database 130. Search engine 120 can be further configured to receive a search query, process the search query and return search results in response to receiving the query.

Search engine 120 can implement the functional units that are shown within the search engine 120, and the processes described herein, using hardware logic such as in an application-specific integrated circuit (ASIC), field-programmable gate array (FPGA), system-on-a-chip (SoC) or other combinations of hardware, firmware and/or software.

In an embodiment, search engine 120 is a vertical search platform that provides scalability and state-of-the art search technology. For example, search engine 120 can provide a multi-filtering tool that exceeds the scope of conventional grouping implemented by for example, the “group-by” and “join” search query statements.

In an embodiment, search engine 120 is configured to perform a method for programmable data multi-filtering of search results. The method comprises a back-end processing and a front-end processing.

In an embodiment, while executing a back-end phase, search engine 120 receives a search query, parses the search query, generates a multiple back-end requests, and executes the back-end requests to generate a set of search results.

In an embodiment, while executing a front-end phase, search engine 120 analyzes and aggregates a set of search results. For example, in the front-end phase, search engine 120 groups the search results and aggregates the search requests according to one or more selection models.

Search engine 120 can group and aggregate data in parallel. For example, search engine 120 can group and aggregate data for each of the multiple back-end requests at the same time. While performing the front-end phase, for each result in a result set generated by a back-end request, search engine 120 can identify the group to which the results belong and the level to which the identified group belongs.

In an embodiment, search engine 120 groups search results into groups by classifying the search results based on different characteristics of the results. For instance, in response to receiving a search query that requests proving titles of music albums recorded after year 2005, search engine 120 can return a list of different music albums performed by different artists. The search results can be grouped by the name of the artist, and/or by the name of the album. Grouping by the name of the artist can be referred to as a first level of grouping, while grouping by the name of the album for each artist can be referred to as a second level of grouping. Hence, the set of songs in the first level are grouped by the name of the artist, and in the second level are grouped by the name of the album for a particular artist.

In an embodiment, search engine 120 generates and collects aggregated data for each group identified at each level. For example, if a result set comprises a list of music albums, and the music albums are grouped by the name of the artist, then aggregated data for a group can include information that is specific to the group. That can include a quantity of music albums found for a particular artist, a quantity of albums within the group, an average price of music album for each artist, a maximum price of music albums for each artist, a minimum price of music albums for each artist, and other types of information.

According to another example, if a result set comprises a list of music albums, and the music albums are grouped by the type of the music, then aggregated data for the group can include information such as a quantity of different albums in the group, an average price of the albums in the group, the maximum price of the albums in the group, the minimum price of the albums in the group, or other types of information.

In an embodiment, search engine 120 also aggregate search results by generating a nested tree for the search results. Aggregating the search results allows displaying the search results as divided into various groups. For example, if a search result query returned three titles of music songs, out of which two songs are credited to one artist and one song is credited to another artist, and each song was a part of a different album, then the search results can be organized in a tree structure having two branches. One branch can depict three music songs organized by the name of the artist (Artist 1, Artist 2), and other branch can depict three music songs organized by the name of the album (Album 1, Album 2, Album 3, Album 4, Album 5).

In an embodiment, search engine 120 provides grouped and aggregated search results. Continuing with the previous example, the search results can be displayed as organized by the name of the artist, and as organized by the name of the album. In addition to the grouping, additional information can be displayed to provide information specific to the group, such as a quantity of the documents in each group, average prices of the documents in each group, maximum and minimum prices in each group, and other information specific to the group.

In an embodiment, search engine 120 comprises one or more processors 102, one or more search units 104, one or more grouping searchers 106, one or more selection transformers 108, one or more grouping executors 110, one or more presenting units 112, and one or more search cores 114a, 114b.

In an embodiment, a processor 102 facilitates communications between search engine 120, and client computers 140a . . . 140n. Furthermore, processor 102 can process commands received and executed by procurement computer 110, processes responses received by search engine 120, and facilitates various types of operations executed by search engine 120. Processor 102 comprises hardware and software logic configured to execute various processes on search engine 120.

In an embodiment, a search unit 104 is configured to receive a search query comprising a query select statement and a plurality of search terms.

In an embodiment, a grouping searcher 106 is configured to generate a plurality of selection models based on a query select statement and a plurality of search terms.

In an embodiment, grouping searcher 106 is further configured to identify one or more hierarchies in the search query, enable execution of one or more nested grouping operations for the search query and enable execution of one or more parallel grouping operations for the search query.

In an embodiment, grouping searcher 106 is further configured to group a plurality of selection results into a final result.

In an embodiment, grouping searcher 106 is further configured to group one or more search terms into one or more groups of features.

In an embodiment, a selection model, from a plurality of selection models, is generated based on a unique combination of one or more terms, from the plurality of search terms, that is not present in other selection models, from the plurality of selection models.

In an embodiment, a selection model can be created by a client application of the user who issued a search query to a search engine 120. A selection model can be an abstract list-manipulation model.

In an embodiment, a selection model can comprise a variety of directives. For example, a set of main directives can comprise an “all” directive for processing an input list as a whole, an “each” directive for processing each element of the input separately, a “group” directive for partitioning the input list into sub-lists, and an “output” directive for including output data in the search results.

In an embodiment, a selection transformer 108 is configured to transform selection models into a plurality of execution models. For example, for each of the plurality of selection models, selection model 108 transforms a selection model into a plurality of execution models.

In an embodiment, selection transformer 108 is further configured to group the plurality of execution results into a selection result. For example, once the execution models are executed by other units of search engine 120, the execution results for the execution models are provided to selection transformer 108, and the execution results are grouped to a selection result.

In an embodiment, a grouping executor 110 is configured to distribute execution models to search cores 114a . . . 114b and to receive execution results from the search cores 114a . . . 114b.

In an embodiment, any of search cores 114a . . . 114b is configured to execute execution models to generate execution results. For example, any of search cores 114a . . . 114b can be configured to execute a plurality of execution models by mining multi-dimensional information stored in storage 130. Furthermore, any of search cores 114a . . . 114b can be configured to access distributed databases associated with a search engine 120.

In an embodiment, each of search cores 114a . . . 114b can be configured to search the same search core repository. Alternatively, each of search cores 114a . . . 114n can be configured to search separate search core repositories.

In an embodiment, grouping executor 110 is further configured to group a plurality of execution results into a selection result in an approximation single-pass process. Alternatively, grouping executor 110 can be configured to group the plurality of execution results to a selection result in a multi-pass process.

In an embodiment, a presenting unit 112 is configured to present final results. For example, the final results can be grouped and aggregated, and the grouped and aggregated results can be sent to a client computer 140a via a network 150.

In an embodiment, presenting unit 112 is further configured to cause displaying a user interface on any of client computers 140a . . . 140n. The user interface can comprise a variety of panels, including a panel for a result display, a panel for a timeline data display, a panel for a hit-map display, a panel for a demographic information display, a panel for a price range display, and other panels.

In an embodiment, various search core repositories are referred to as storage 130. Storage 130 can be configured to store a variety of information, including information related to search queries, selection models, execution models, execution results, selection results, and any other information that search engine 120 may require.

In an embodiment, search engine 120 communicates with one or more client computers 140a . . . 140n via a communications network 150.

For purposes of illustrating clear examples, FIG. 1 shows one or more client computers 140a . . . 140n, and one network 150. However, practical embodiments may use any number of client computers 140, and any number of networks 150.

In an embodiment, network 150 is communicatively coupled to client computers 140a . . . 120n, and search engine 120. Network 150 is used to maintain various communications sessions and may implement one or more communications protocols.

Each client computer 140a . . . 120n, and search engine 120 can be any type of a workstation, laptop, PDA device, phone, or a portable device.

Client computers 140a . . . 140n and search engine 120 may implement the processes described herein using hardware logic such as in an application-specific integrated circuit (ASIC), field-programmable gate array (FPGA), system-on-a-chip (SoC) or other combinations of hardware, firmware and/or software.

In an embodiment, client computers 140a . . . 140n, search engine 120 and network 150 comprise hardware or software logic configured to generate and maintain various types of communications session information, and routing information for data communications network 150.

In an embodiment, client computers 140a . . . 140n can be used by users who issued search queries to a search engine 120. For example, from a client computer 140a, a search query can be sent via a network 150 to search engine 120 for processing, and multi-filtered results can be sent from search engine 120 via a network 150 back to the client computer 140a.

3.0 Programmable Multi-Filtering of Search Results

In an embodiment, an approach for multi-filtering of multi-dimensional information is presented. The multi-filtering can be implemented on a variety of search platforms. For example, the multi-filtering can be implemented a vertical search platform “Vespa 4.0” that provides scalability and state-of-the-art search technology and that is available from Yahoo! Inc., Santa Clara, Calif.

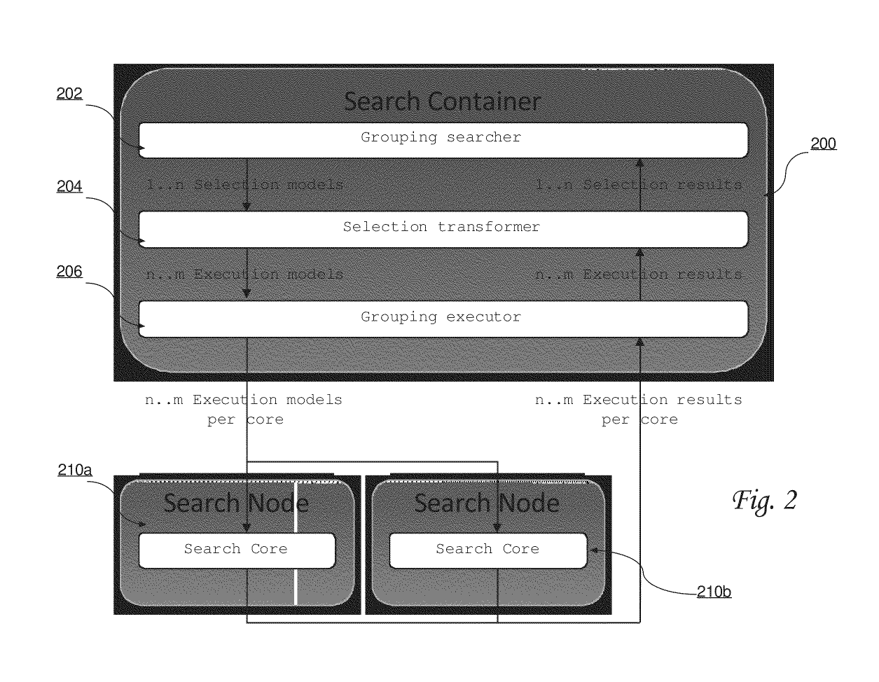

FIG. 2 illustrates a data flow associated with processing grouping requests. In an embodiment, FIG. 2 depicts a search container 200, and one or more search cores 210a . . . 210b. Search container 200 comprises a grouping searcher 202, a selection transformer 204 and a grouping executor 206, each of which was briefly described in reference to FIG. 1. Search cores 210a . . . 210b can run multiple select statements in parallel for the same query.

In an embodiment, a search container 200 is a multi-filtering tool and is configured to perform a multi-filtering.

In an embodiment, a search container 200 performs multi-filtering by utilizing a ranking framework for deriving and executing various ranking expressions tailored for various applications. The ranking expressions can be designed to perform various math operations as well as conditional branching. The ranking expressions can operate on a variety of document attributes.

In an embodiment, a search container 200 is configured to execute an approach for multi-filtering by executing two types of processing: a front-end processing and a back-end processing.

A front-end processing involves initiating one or more search container instances that run one or more searcher plug-ins. The front-end processing enables grouping across multiple search cores without peer communication, and thus, parts of the grouping logic can be implemented as searcher plug-ins.

In an embodiment, a front-end processing starts with a grouping searcher 202 generating one or more selection models based on a received search query.

In an embodiment, generating one or more selection models is a client-type grouping. The client-type grouping requests are referred to as the selection models. The selection models can be represented as tree-type models, and can be created programmatically.

The example below is used to illustrate a data flow associated with processing grouping requests as described in FIG. 2. In this example, it is assumed that a user issued an SQL search query: SELECT COUNT (*) FROM orders WHERE customer=‘Smith.” In SQL, the processing of the above search query would require at least two processing phases. The first phase can be referred to as an initial processing, and comprises accessing the table called “orders,” and selecting those records from the table called “orders” that contain information about “Smith.” The second phase can be referred to as a post-processing, and comprises counting the number of records from the table “orders” that indeed contain the information about “Smith.” The two-step processing can be inefficient and time-consuming at times.

In contrast to the SQL processing, in an embodiment, a grouping searcher 202 of the search container 200, can represent the above user search query using the following expression: all(group(customer) each(output(count( )))). Based on the expression, grouping searcher 202 can generate various grouping instructions. The examples of the grouping instructions depend on the implementation.

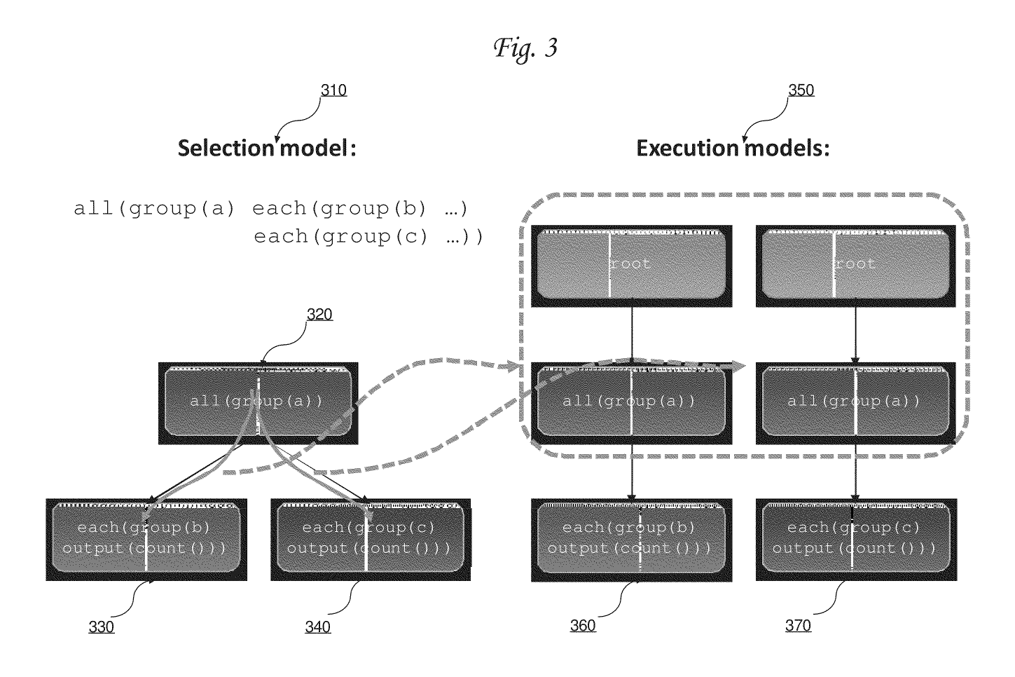

In an embodiment, a grouping searcher 202 is configured to generate one or more selection models. An example of an embodiment of generating selection models is depicted in FIG. 3.

FIG. 3 illustrates an embodiment of generating selection models and execution models. In the example depicted in FIG. 3, one or more selection models are generated for an expression “all (group(a) each (group(b) . . . ) each (group(c) . . . )).” The expression indicates a group(a) 320, a group(b) 330, and a group(c) 340. The group(a) 320 is displayed above group(b) 330 and group(c) 340. Group(a) 320 has an associated level. Group(b) 330 and group(c) 340 also have an associated level. The level associated with group(a) 320 is higher than the level associated with group(b) 330 and group(c) 340.

In an embodiment, for each group identified in a selection model 310, one or more execution models 350 are generated. The one or more execution models 350 can be generated by a selection transformer 204 of FIG. 2.

In an embodiment, a selection transformer 204 of FIG. 3 is configured to generate execution models. For example, selection transformer 204 receives one or more selection models, and based on the selection model information, selection transformer 204 generates a plurality of execution models. An example of an embodiment of generating the execution models is depicted in FIG. 3.

Continuing with the description of FIG. 3, one or more execution models are generated for one or more groups of selection model 310. In the example depicted in FIG. 3, an execution model 360 is generated for a group(a) 320 and a group(b) 330, and an execution model 370 is generated for a group(a) and a group(c) 340. The execution model 360 is a separate model from the execution model 370. As depicted in FIG. 3, the execution model 360 comprises a root, an expression “all(group(a))” and an expression (each(group(b) output(count( )), while the execution model 370 comprises a root, an expression “all(group(a))” and an expression (each(group(c) output(count( )). In an embodiment, there is one execution model for each path through the selection model from root to any leaf. The transformation process is also able to discard execution models that either have no outputs, or that can be collapsed into another parallel execution model.

In an embodiment, one or more execution models are sent to a grouping executor 206, depicted in FIG. 2.

Continuing with the description of FIG. 2, in an embodiment, a grouping executor 206 is configured to generate execution models for each search core. For example, grouping executor 206 can receive a plurality of execution modes, and use the execution models to generate a plurality of execution models for each core search. For instance, if two search cores have been identified by grouping executor 206, then grouping executor 206 can generate a plurality of execution models for the first search core, and a plurality of execution models for the second search core.

In an embodiment, each of the plurality of execution models is executed by search cores 210a . . . 210b. Although FIG. 2, depicts two search cores 210a . . . 210b, more than two search cores 210 can be dedicated to execute the execution models.

In an embodiment, once search cores 210a . . . 210b finish processing the plurality of execution models, the search cores 210a . . . 210b provide a plurality of execution results for search cores to a grouping executor 206.

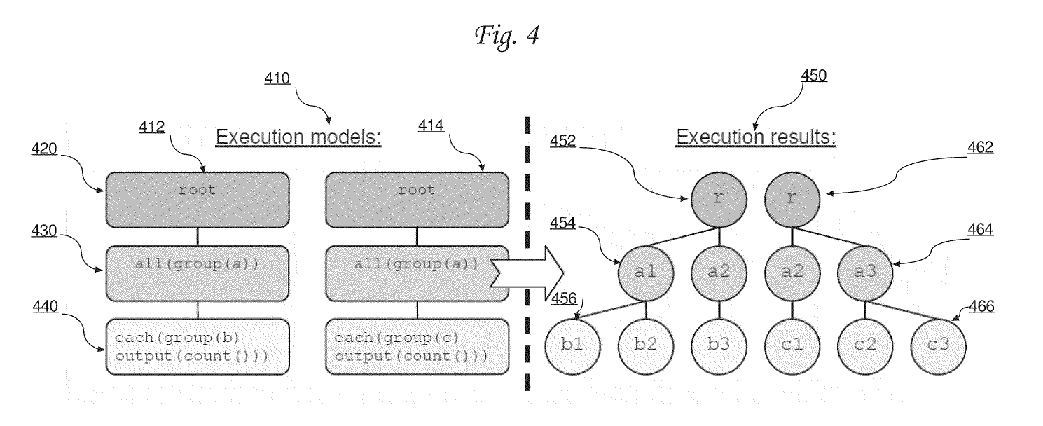

In an embodiment, a grouping executor 206 groups execution results provided for each search core into a plurality of execution results. An example of grouping the plurality of the execution results for search cores is depicted in FIG. 4.

FIG. 4 illustrates an embodiment of relationship between an execution model and execution result. In the example depicted in FIG. 4, execution results 450 are grouped for a plurality of execution models 410. In particular, FIG. 4 depicts two execution models: an execution model 412 comprises a root 420, an expression “all (group(a))” 430 and an expression “(each(group(b) output(count( ))” 440, while an execution model 414 comprises other respective clauses. Beneath the grouping executor sits a dispatch that scatters the execution model across all search cores, and the same dispatch merges the result so that a the grouping searcher gets exactly one execution result per execution model.

As depicted in FIG. 4, for an execution model 412, a grouping executor 206 is matched with one execution result in the following manner: an execution result generated for a root 420 of an execution model 412 is referred to as execution result 452; an execution result generated for an “all(group(a))” expression 430 of the execution model 412 is referred to as execution result 454, and an execution result generated for a clause “each(group(b) output(count( )))” 440 is referred to as execution results 456.

Similarly, execution model 414 is matched with exactly one execution result.

In an embodiment, execution results can be represented in a tree-structure 450. The tree has two branches: a branch 452-454-456, which comprises execution results generated for an execution model 412; and a branch 462-464-466, which comprises execution results generated for an execution model 414. Cumulatively, the branch 452-454-456 comprises results r+a1+a2+b1+b2+b3, while branch 462-464-466 comprises results r+a2+a3+c1+c2+c3.

As depicted in FIG. 4, grouping of the execution results can cause a repetition of some execution results in a tree-structure of the execution results. In the depicted example, the results “r” and “a2” are included in both branches.

In an embodiment, grouping of the execution results can be performed using custom expressions, such as group clauses. The expressions can comprise numerical constants, document attributes, functions defined over another expressions (such as md5, cat, xor, and, or, add, sub, mul, div, mod), data types of expressions resolved using best effort, arithmetical operands, and other types of expressions.

TABLE 1 (below) illustrates examples of various expressions that can be used to group execution results:

TABLE 1

| | | | |
|---|---|---|---|
| Name | Description | Arguments | Result |

Arithmetic expressions

| | | | |
|---|---|---|---|
| add | Add the arguments together. | Numeric+ | Numeric |
| + | Add left and right argument. | Numeric, Numeric | Numeric |
| mul | Multiply the arguments together. | Numeric+ | Numeric |
| * | Multiply left and right argument. | Numeric, Numeric | Numeric |
| sub | Subtract second argument from | Numeric+ | Numeric |
| | first, third from result, etc. | | |
| − | Subtract right argument from | Numeric, Numeric | Numeric |
| | left. | | |
| div | Divide first argument by second, | Numeric+ | Numeric |
| | result by third, etc. | | |
| / | Divide left argument by right. | Numeric, Numeric | Numeric |
| mod | Modulo first argument by | Numeric+ | Numeric |
| | second, result by third, etc. | | |
| % | Modulo left argument by right. | Numeric, Numeric | Numeric |
| neg | Negate argument. | Numeric | Numeric |
| − | Negate right argument. | Numeric | Numeric |

Bitwise expressions

| | | | |
|---|---|---|---|
| and | AND the arguments in order. | Long+ | Long |
| or | OR the arguments in order. | Long+ | Long |
| xor | XOR the arguments in order. | Long+ | Long |

String expressions

| | | | |
|---|---|---|---|
| strlen | Count the number of bytes in | String | Long |
| | argument. | | |
| strcat | Concatenate arguments in order. | String+ | String |

Type conversion expressions

| | | | |
|---|---|---|---|
| todouble | Convert argument to double. | Any | Double |
| tolong | Convert argument to long. | Any | Long |
| tostring | Convert argument to string. | Any | String |
| toraw | Convert argument to raw. | Any | Raw |

Raw data expressions

| | | | |
|---|---|---|---|
| cat | Cat the binary representation of | Any+ | Raw |
| | the arguments together. | | |
| md5 | Does an md5 over the binary | Any | Raw |
| | representation of the argument, | | |
| | and keeps the lowest 64 bits. | | |

Accessor expressions

| | | | |
|---|---|---|---|
| relevance | Return the computed rank of a | None | Double |
| | document. | | |
| <attribute-name> | Return the value of the named | None | Any |
| | attribute. | | |

Bucket expressions

| | | | |
|---|---|---|---|
| fixedwidth | Maps the value of the first | Any, Numeric | NumericBucketList |
| | argument into second argument | | |
| | number of fixed width buckets. | | |
| predefined | Maps the value of the first | Any Bucket+ | BucketList |
| | argument into the given buckets. | | |

Time expressions

| | | | |
|---|---|---|---|
| time.dayofmonth | Returns the day of month (1-31) | Long | Long |
| | for the given timestamp. | | |
| time.dayofweek | Returns the day of week (0-6) | Long | Long |
| | for the given timestamp, | | |
| | Monday being 0. | | |
| time.dayofyear | Returns the day of year (0-365) | Long | Long |
| | for the given timestamp. | | |
| time.hourofday | Returns the hour of day (0-23) | Long | Long |
| | for the given timestamp. | | |
| time.minuteofhour | Returns the minute of hour (0- | Long | Long |
| | 59) for the given timestamp. | | |
| time.monthofyear | Returns the month of year (1-12) | Long | Long |
| | for the given timestamp. | | |
| time.secondofminute | Returns the second of minute (0- | Long | Long |
| | 59) for the given timestamp. | | |
| time.year | Returns the full year (e.g. 2009) | Long | Long |
| | of the given timestamp. | | |

List expressions

| | | | |
|---|---|---|---|
| size | Return the number of elements | Any | Long |
| | in the argument if it is a list. If | | |
| | not return 1. | | |
| sort | Sort the elements in argument in | Any | Any |
| | ascending order if argument is a | | |
| | list If not it is a NOP. | | |
| reverse | Reverse the elements in the | Any | Any |
| | argument if argument is a list If | | |
| | not it is a NOP. | | |

Other expressions

| | | | |
|---|---|---|---|
| zcurve.x | Returns the X component of the | Long | Long |
| | given zcurve encoded 2d point. | | |
| zcurve.y | Returns the Y component of the | Long | Long |
| | given zcurve encoded 2d point. | | |
| uca | Converts the attribute string | Any Locale(String), | Raw |
| | using unicode collation | Strength(String) | |
| | algorithm, useful for sorting. | | |

Single argument standard mathematical expressions

| | | |
|---|---|---|
| math.exp | Double | Double |
| math.log | Double | Double |
| math.log 1p | Double | Double |
| math.log 10 | Double | Double |
| math.sqrt | Double | Double |
| math.cbrt | Double | Double |
| math.sin | Double | Double |
| math.cos | Double | Double |
| math.tan | Double | Double |
| math.asin | Double | Double |
| math.acos | Double | Double |
| math.atan | Double | Double |
| math.sinh | Double | Double |
| math.cosh | Double | Double |
| math.tanh | Double | Double |
| math.asinh | Double | Double |
| math.acosh | Double | Double |
| math.atanh | Double | Double |

Dual argument standard mathematical expressions

| | | | |
|---|---|---|---|
| math.pow | Return X\hat{ }Y. | Double, Double | Double |
| math.hypot | Return length of hypothenus | Double, Double | Double |
| | given X and Y sqrt(X\hat{ }2 + Y\hat{ }2). | | |

TABLE 2 (below) illustrates an example of the language grammar that can be used to generate custom expressions:

TABLE 2
Language grammar

| | |
|---|---|
| request | ::= group [ “where” “(” ( “true” \| “$query” ) “)” ] |
| group | ::= ( “all” \| “each”) “(” operations “)” [ “as” “(” identifier “)” ] |
| operations | ::= [ “group” “(” expression “)” ] |
| | ( ( “alias” “(” identifier “,” expression “)” ) \| |
| | ( “max” “(” number “)” ) \| |
| | ( “order” “(” expList \| aggrList “)” ) \| |
| | ( “output” “(” aggrList “)” ) \| |
| | ( “precision” “(” number “)” ) )* |
| | group* |
| aggrList | ::= aggr ( “,” aggr )* |
| aggr | ::= ( ( “count” “(” “)” ) \| |
| | ( “sum” “(” exp “)” ) |
| | ( “avg” “(” exp “)” ) \| |
| | ( “max” “(” exp “)” ) \| |
| | ( “min” “(” exp “)” ) |
| | ( “xor” “(” exp “)” ) \| |
| | ( “summary” “(” [ identifier ] “)” ) ) |
| | [ “as” “(” identifier “)” ] |
| expList | ::= exp ( “,” exp )* |
| exp | ::= ( “+” \| “−”) ( “$” identifier [ “=” math ] ) \| ( math ) \| ( aggr ) |
| math | ::= value [ ( “+” \| “−” \| “*” \| “/” \| “%” ) value ] |
| value | ::= ( “(” exp “)” ) \| |
| | ( “add” “(” expList “)” ) \| |
| | ( “and” “(” expList “)” ) \| |
| | ( “cat” “(” expList “)” ) \| |
| | ( “div” “(” expList “)” ) \| |
| | ( “fixedwidth” “(” exp “,” number “)” ) \| |
| | ( “math” “.” ( |
| | ( |
| | “exp” \| “log” \| “log1p” \| “log10” \| “sqrt” \| “cbrt” \| |
| | “sin” \| “cos” \| “tan” \| “asin” \| “acos” \| “atan” \| |
| | “sinh” \| “cosh” \| “tanh” \| “asinh” \| “acosh” \| “atanh” |
| | ) “(” exp “)” \| |
| | ( “pow” \| “hypot” ) “(” exp “,” exp “)” |
| | )) \| |
| | ( “max” “(” expList “)” ) \| |
| | ( “md5” “(” exp “,” number “,” number “)” ) \| |
| | ( “min” “(” expList “)” ) \| |
| | ( “mod” “(” expList “)” ) \| |
| | ( “mul” “(” expList “)” ) \| |
| | ( “or” “(” expList “)” ) \| |
| | ( “predefined” “(” exp “,” “(” bucket ( “,” bucket )* “)” “)” ) \| |
| | ( “reverse” “(” exp “)” ) \| |
| | ( “relevance” “(” “)” ) \| |
| | ( “sort” “(” exp “)” ) \| |
| | ( “strcat” “(” expList “)” ) \| |
| | ( “strlen” “(” exp “)” ) \| |
| | ( “size” “(” exp“)” ) \| |
| | ( “sub” “(” expList “)” ) \| |
| | ( “time” “.” ( “year” \| “monthofyear” \| “dayofmonth” \| “dayofyear” \| “dayofweek” \| |
| | “hourofday” \| “minuteofhour” \| “secondofminute” ) “(” exp “)” ) \| |
| | ( “todouble” “(” exp “)” ) \| |
| | ( “tolong” “(” exp “)” ) \| |
| | ( “tostring” “(” exp “)” ) \| |
| | ( “toraw” “(” exp “)” ) \| |
| | ( “uca” “(” exp “,” string [ “,” string ] “)” ) \| |
| | ( “xor” “(” expList “)” ) \| |
| | ( “zcurve” “.” ( “x” \| “y” ) “(” exp “)” ) \| |
| | ( attributeName ) |
| bucket | ::= “bucket” ( “(” \| “[” \| “<”) ) ( “−inf” \| rawvalue \| number \| string ) |
| | [ “,” ( “inf” \| rawvalue \| number \| string ) ] (“)” \| “+” \| “>”) |
| rawvalue | ::= “{” ( ( string \| number) “,”)* “}” |

In an embodiment, a type of the results generated by custom expressions can be either scalar or single dimension arrays. For example, an expression “add(<array>)” adds all elements together to produce a scalar. Adding elements to arrays can produce a new array with length of max(|A|, |B|). The type of the elements can match the arithmetic type rules for scalar values.

In an embodiment, groups can contain subgroups. The subgroups can be generated by using sub-expressions and group operations).

In an embodiment, groups can be nested within any number of levels. Each level of grouping can specify a set of aggregates configured to collect search results that belong to the particular group.

Aggregated information for a particular group can comprise various types of information. For example, the aggregated information can comprise a list of documents retrieved using a particular summary class. Furthermore, the aggregated information can comprise the count of the documents in the group. Moreover, the aggregated information can comprise the sum, average, min, max, or xor computed for the expression associated with the group.

TABLE 3 (below) illustrates an example of aggregators that can be used to aggregate information:

TABLE 3

| | | | |
|---|---|---|---|
| Name | Description | Arguments | Result |

Group aggregators

| | | | |
|---|---|---|---|
| count | Simply increments a long counter everytime it is | None | Long |
| | invoked. | | |
| sum | Sums the argument over all selected documents. | Numeric | Numeric |
| avg | Computes the average over all selected documents. | Numeric | Numeric |
| min | Keeps the minimum value of selected documents. | Numeric | Numeric |
| max | Keeps the maximum value of selected documents. | Numeric | Numeric |
| xor | XOR the values (their least significant 64 bits) of all | Any | Long |
| | selected documents. | | |

Hit aggregators

| | | | |
|---|---|---|---|
| summary | Produces a summary of the requested summary class. | Name of | Summary |
| | | summary class | |

In an embodiment, an order in which the search results can be ordered can be determined for some or all levels of grouping. For example, an order for grouping the documents within a particular group can be defined and associated with a particular level of the grouping.

TABLE 4 (below) illustrates examples of grouping:

```
TABLE 4
TopN/Full corpus Grouping
A simple example of grouping provisioning for counting the number of documents in each group
can be expressed as all(group(a) each(output(count( )))).
Two parallel groupings can be expressed as:
all(all(group(a) each(output(count( ))))
  all(group(b) each(output(count( )))))
A simple example of grouping provisioning for grouping only the 1000 best hits at each search
core node (providing a lower accuracy, but a higher speed) can be expressed as: all(max(1000)
all(group(a) each(output(count( )))))
A simple example of grouping provisioning for grouping of all search results can be expressed
as: all(group(a) each(output(count( )))) where(true).
Locale aware sorting
A simple example of grouping with a local aware sorting can be expressed as:
all(group(s) order(max(uca(s, “sv”))) each(output(count( ))))
all(group(s) order(max(uca(s, “sv”, “PRIMARY”))) each(output(count( ))))
Grouping and multivalue fields
A simple example of grouping based on a map from strings to integers, where the strings are can
be processed by a sort of key can be expressed as:
all(group(mymap.key) each(output(sum(mymap.value))))
Ordering groups
A simple example of grouping using a modulo-5 operation before the group is selected can be
expressed as:
all(group(a % 5) order(sum(b)) each(output(count( ))))
Collecting aggregates
A simple example of grouping where the number of documents in each group is counted and the
best hit in each group is returned can be expressed as:
all(group(a) each(max(1) each(output(summary( )))))
Predefined buckets
A simple example of grouping based on predefined buckets for a raw attribute value can be
expressed as:
all(group(predefined(age, [0, 10>, [10,inf>)) each(outtput(count( ))))
Other Grouping Examples
Single level grouping on “a” attribute, returning at most 5 groups with full hit count as well as
the 69 best hits.
all(group(a) max(5) each(max(69) output(count( )) each(output(summary( )))))
Two level grouping on “a” and “b” attribute:
all(group(a) max(5) each(output(count( ))
  all(group(b) max(5) each(max(69) output(count( )) each(output(summary( )))))))
Three level grouping on “a”, “b” and “c” attribute:
all(group(a) max(5) each(output(count( ))
  all(group(b) max(5) each(output(count( ))
    all(group(c) max(5) each(max(69) output(count( )) each(output(summary( )))))))
As above example, but also collect best hit in level 2:
all(group(a) max(5) each(output(count( ))
  all(group(b) max(5) each(output(count( ))
    all(max(1) each(output(summary( ))))
    all(group(c) max(5) each(max(69) output(count( )) each(output(summary( )))))))
As above example, but also collect best hit in level 1:
all(group(a) max(5) each(output(count( ))
  all(max(1) each(output(summary( ))))
  all(group(b) max(5) each(output(count( ))
    all(max(1) each(output(summary( ))))
    all(group(c) max(5) each(max(69) output(count( )) each(output(summary( )))))))
As above example, but using different document summaries on each level:
all(group(a) max(5) each(output(count( ))
  all(max(1) each(output(summary(complexsummary))))
  all(group(b) max(5) each(output(count( ))
    all(max(1) each(output(summary(simplesummary))))
    all(group(c) max(5) each(max(69) output(count()) each(output(summary(fastsummary)))))))
Group on fixed width buckets for numeric attribute, then on “a” attribute, count hits in leaf
nodes:
all(group(fixedwidth(n, 3)) each(group(a) max(2) each(output(count( )))))
As above example, but limiting groups in level 1, and returning hits from level 2:
all(group(fixedwidth(n, 3)) max(5) each(group(a) max(2) each(output(count( ))
each(output(summary( ))))))
Deep grouping with counting and hit collection on all levels:
all(group(a) max(5) each(output(count( ))
  all(max(1) each(output(summary( ))))
  all(group(b) each(output(count( ))
    all(max(1) each(output(summary( ))))
    all(group(c) each(output(count( ))
      all(max(1) each(output(summary( ))))))))))
Time aware grouping
Group by year:
all(group(time.year(a)) each(output(count( ))))
Group by year, then by month:
all(group(time.year(a)) each(output(count( ))
  all(group(time.month(a)) each(output(count( ))))))
Group by year, then by month, then day, then by hour:
all(group(time.year(a)) each(output(count( ))
  all(group(time.monthofyear(a)) each(output(count( ))
    all(group(time.dayofmonth(a)) each(output(count( ))
      all(group(time.hourofday(a)) each(output(count( ))))))))))
Groups today, yesterday, lastweek, and lastmonth using predefined aggregator, and groups each
day within each of these separately:
all(group(predefined((now( ) − a) / (60 * 60 * 24), bucket(0,1), bucket(1,2), bucket(3,7),
bucket(8,31))) each(output(count( ))
  all(max(2) each(output(summary( ))))
  all(group((now( ) − a) / (60 * 60* 24)) each(output(count( )) all(max(2)
each(output(summary( ))))))))
```

In an embodiment, ordering of the grouped search results can be performed using any of the available aggregates.

In an embodiment, a multi-filtering can be used to implement various types of search results ordering. For example, the multi-filtering can be used to implement a strict ordering of the search results. Other types of ordering can include an ascending ordering, a descending ordering and any type of ordering specified for each level of the grouping.

In an embodiment, a quantity of groups returned for each level can be restricted. This can be accomplished by using for example, a “max” operation expression, and allowing returning only for example, first n groups as specified by the order operation.

Continuing with the description of FIG. 2, in an embodiment, a grouping executor 206 is also configured to transmit a plurality of execution results to a selection transformer 204.

In an embodiment, a selection transformer 204 receives a plurality of execution results and generates one selection result per selection model.

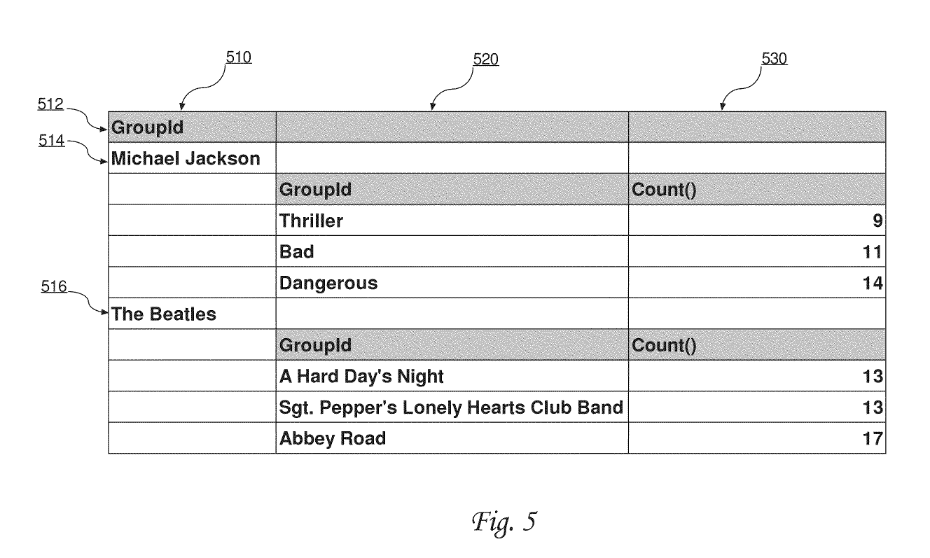

In an embodiment, a grouping searcher received one or more selection results and displays the selection results grouped according to one or more selection models. Example of the grouped selection results is depicted in FIG. 5.

FIG. 5 illustrates an example of a display for grouped search results. The example depicted in FIG. 5 illustrates search results generated for a search query seeking a count for each of three most popular songs performed by Michael Jackson and a count for each of three most popular songs performed by The Beatles. A count may represent for example, the count of different recordings of a particular song, the count of websites providing the recording of a particular song, or any other related count.

FIG. 5 comprises three columns: a first GroupId column 510, a second GroupId column 520 and a count column 530. In the first GroupId column 510, labeled “GroupId” 512, two group identifiers are listed: GroupId 514 “Michael Jackson,” and GroupId 516 “The Beatles.”

In the second GroupId column 520, the names of the songs are listed. The names of the songs are organized by the group identifiers. In particular, for the GroupId 514 “Michael Jackson,” three most popular songs include: “Thriller,” “Bad,” and “Dangerous.” For the GroupId 516 “The Beatles,” three most popular songs include: “A Hard Day's Night,” “Sgt. Pepper's Lonely Hearts Club Band,” and “Abbey Road.” In the example depicted in FIG. 5, the lists were truncated to three elements (songs); however, in other implementation, a list can comprise any number of elements.

In FIG. 5, execution of the search query returned search results, and the search results are organized by a GroupId. As depicted in FIG. 5, the search results can be displayed in a count column 530. In the depicted example, it was determined that the count of M. Jackson's “Thriller” was 9, the count of M. Jackson's “Bad” was 11, the count of M. Jackson's “Dangerous” was 14, the count of The Beatles' “A Hard Day's Night” was 13, the count of The Beatles' “Sgt. Pepper's Lonely Hearts Club Band” was 13, and the count of The Beatles' “Abbey Road” was 17.

In an embodiment, results grouping can produce groups that contain outputs, group lists, and hit lists. Group lists can contain sub-groups, and hit lists can contain hits that are part of the owning group.

4.0 Example of an Embodiment of Programmable Multi-Filtering

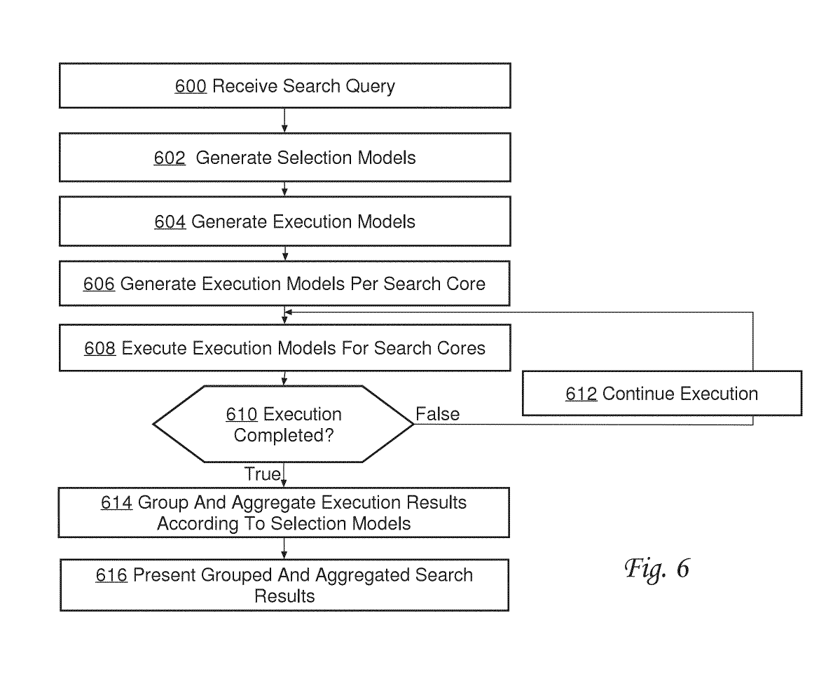

FIG. 6 illustrates an embodiment of an approach for programmable multi-filtering.

In step 600, a search engine receives a search query. The search query can be issued by a client application executed on a user computer. The search query can be issued to request one or more search results that satisfy the terms present in the search query.

In step 602, a search engine generates one or more selection models for the received search query. The details of generating the one or more selection models are provided in the description of FIG. 2-3.

In step 604, a search engine generates one or more execution models based on the one or more selection models generated for the search query. The details of generating the one or more execution models are provided in the description of FIG. 2 and FIG. 4.

In step 606, a search engine generates one or more execution models for each search core. The execution models can be customized according to the search core available to a particular search core. For example, if two search cores are available to perform a search, then the search engine can generate two execution models, each model for one search core. An example of generating the one or more execution models is provided in the description of FIG. 2 and FIG. 4.

In step 608, each search core will receive the same set of execution models. The execution of the execution models can be performed in parallel by each search core, and thus execution of the execution models can be performed simultaneously by the search cores. The details of executing the execution models are provided in the description of FIG. 2.

In step 610, a search engine checks whether the execution of all execution models has been completed. If the execution of the execution models has not been completed, then the process proceeds to step 612, in which the execution of the execution models is continued.

However, if the execution of the execution models has been completed, then the proceeds to step 614.

In step 614, a search engine receives a plurality of execution results, and generates selection results. Generating of the selection results can be performed online or offline. If the generation is performed online, then the selection results can be immediately provided to the user. If the generation is performed offline, then the selection results can be provided to the user with some delay. The details are provided in the description of FIG. 2-4.

In step 616, a search engine presents the selection results to a user. The selection results can be aggregated. An example of the selection results is described in FIG. 4.

5.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

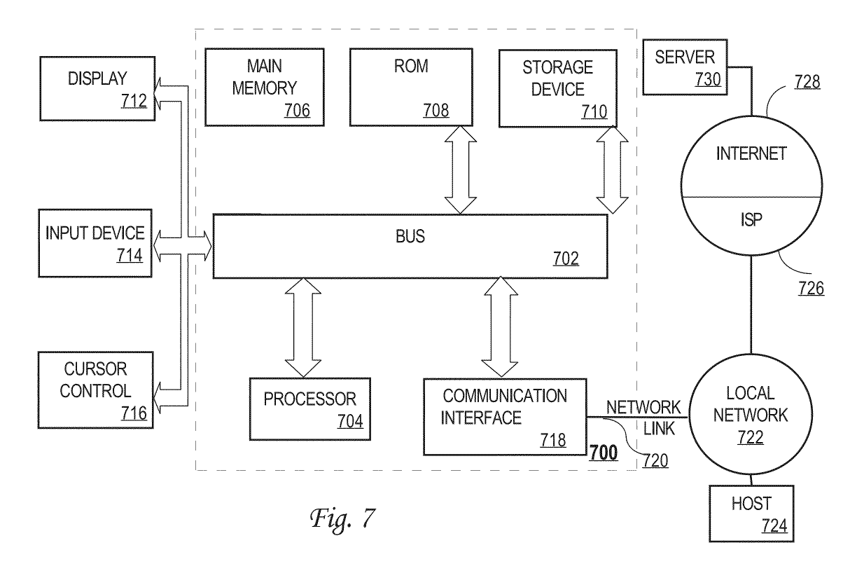

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (LCD, CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

6.0 Extensions and Alternatives

In the foregoing specification, embodiments of the invention have been described with reference to numerous specific details that may vary from implementation to implementation. The specification and drawings are, accordingly, to be regarded in an illustrative rather than a restrictive sense.

What is claimed is:

1. A method comprising:
receiving a search query comprising a query select statement and a plurality of search terms;
generating a plurality of selection models based on the query select statement and the plurality of search terms;
wherein each selection model, from the plurality of selection models, comprises a unique combination of one or more terms, from the plurality of search terms, that is not present in other selection models, from the plurality of selection models;
obtaining a plurality of particular selection results for a particular selection model for each particular selection model, from the plurality of models;
grouping the plurality of particular selection results into a final result and aggregating the final result according to the plurality of selection models;
presenting the aggregated final result;
wherein the method is performed by one or more special-purpose computing devices.

2. The method of claim 1, further comprising:
identifying one or more hierarchies in the search query;
enabling execution of one or more nested grouping operations for the search query;
enabling execution of one or more parallel grouping operations for the search query;
grouping the one or more search terms into one or more groups of features.

3. The method of claim 1,
wherein obtaining a particular selection result for a particular selection model comprises:
transforming the particular selection model into a plurality of execution models;
distributing the plurality of execution models to one or more search cores for execution;
receiving a plurality of execution results from the one or more search cores;
merging the plurality of execution results into a particular selection result;
wherein the particular selection result comprises results for the particular selection model.

4. The method of claim 3, wherein the merging the plurality of execution results into a selection result is performed as a multi-pass process.

5. The method of claim 3, wherein merging the plurality of execution results into a particular selection result is performed as an approximation single-pass process.

6. The method of claim 1, wherein presenting the aggregated final result comprises generating and displaying a user interface;
wherein the user interface comprises a result display, and any of a timeline data display, a hit-map display, a demographic information display, a price range display.

7. The method of claim 1, wherein the one or more search cores execute the plurality of execution models by mining multi-dimensional information extracted from distributed search engine results.

8. An apparatus comprising:
one or more processors;
a search unit configured to receive a search query comprising a query select statement and a plurality of search terms;
a grouping searcher configured to generate a plurality of selection models based on the query select statement and the plurality of search terms;
wherein a selection model, from the plurality of selection models, comprises a unique combination of one or more terms, from the plurality of search terms, that is not present in other selection models, from the plurality of selection models;
a selection transformer configured to perform:
for each of the plurality of selection models, transform a selection model into a plurality of execution models;
a grouping executor configured to perform:
for each of the plurality of selection models:
distribute the plurality of execution models to one or more search cores for execution;
receive a plurality of execution results from the one or more search cores;
the selection transformer further configured to perform:
group the plurality of execution results into a selection result;
wherein the selection result comprises results to the selection model, from the plurality of selection models;
the grouping searcher further configured to group a plurality of selection results into a final result, and aggregate the final result according to the plurality of selection models;
a presenting unit configured to present the aggregated final result.

9. The apparatus of claim 8, wherein the grouping searcher is further configured to:
identify one or more hierarchies in the search query;
enable execution of one or more nested grouping operations for the search query;
enable execution of one or more parallel grouping operations for the search query.

10. The apparatus of claim 8, wherein the grouping executor is further configured to group the plurality of execution results into a selection result in an approximation single-pass process.

11. The apparatus of claim 8, wherein the grouping executor is further configured to group the plurality of execution results into a selection result in a multi-pass process.

12. The apparatus of claim 8, wherein the grouping searcher is further configured to group the one or more search terms into one or more groups of features.

13. The apparatus of claim 8, wherein the presenting unit is further configured to display a user interface;
wherein the user interface comprises a result display, and any of a timeline data display, a hit-map display, a demographic information display, a price range display.

14. The apparatus of claim 8, wherein the one or more search cores execute the plurality of execution models by mining multi-dimensional information extracted from distributed search engine results.

15. One or more non-transitory storage media storing instructions which, when executed by one or more computing devices, cause performance of the method recited in claim 1.

16. One or more non-transitory storage media storing instructions which, when executed by one or more computing devices, cause performance of the method recited in claim 2.

17. One or more non-transitory storage media storing instructions which, when executed by one or more computing devices, cause performance of the method recited in claim 3.

18. One or more non-transitory storage media storing instructions which, when executed by one or more computing devices, cause performance of the method recited in claim 4.

19. One or more s non-transitory storage media storing instructions which, when executed by one or more computing devices, cause performance of the method recited in claim 5.

20. One or more non-transitory storage media storing instructions which, when executed by one or more computing devices, cause performance of the method recited in claim 6.
